(19) United States
(12) Patent Application Publication
(10) Pub. No.: US 2023/0418311 A1
(43) Pub. Date: Dec. 28, 2023

(54) METHOD FOR DETECTING LANDING OF UNMANNED AERIAL VEHICLE, ELECTRONIC DEVICE AND UNMANNED AERIAL VEHICLE

(71) Applicant: AUTEL ROBOTICS CO., LTD., Shenzhen (CN)

(72) Inventors: Kai ZHANG, Shenzhen (CN); Yanfeng DANG, Shenzhen (CN)

(73) Assignee: AUTEL ROBOTICS CO., LTD., Shenzhen (CN)

(21) Appl. No.: 18/209,459

(22) Filed: Jun. 13, 2023

(30) Foreign Application Priority Data
Jun. 24, 2022 (CN) 202210731125.6

(51) Int. Cl. G05D 1/10; B64U 20/70; B64U 10/14; B64D 45/04

(52) U.S. Cl. CPC G05D 1/106; B64U 20/70; B64U 10/14; B64D 45/04

(57) ABSTRACT

A method for detecting landing of an unmanned aerial vehicle includes: acquiring a current ground clearance of each supporting vertical rod; acquiring a current height above ground of the unmanned aerial vehicle when receiving a landing instruction; determining whether a fuselage of the unmanned aerial vehicle is horizontal; when the fuselage of the unmanned aerial vehicle is horizontal, adjusting a length of the supporting vertical rod according to the current ground clearance of the supporting vertical rod to keep the fuselage horizontal when the unmanned aerial vehicle lands; and controlling the unmanned aerial vehicle to descend for landing.

### CROSS-REFERENCE TO RELATED APPLICATION

This application claims priority of Chinese Patent Application No. 202210731125.6, filed on Jun. 24, 2022, entitled as “METHOD FOR DETECTING LANDING OF UNMANNED AERIAL VEHICLE, ELECTRONIC DEVICE AND UNMANNED AERIAL VEHICLE,” the entire disclosure of which is incorporated herein by reference for all purposes.

### TECHNICAL FIELD

The present disclosure relates to the field of unmanned aerial vehicles, and in particular to a method for detecting landing of an unmanned aerial vehicle, an electronic device and an unmanned aerial vehicle.

### BACKGROUND

With popularity of unmanned aerial vehicles, the number and density of unmanned aerial vehicles flying in local airspace are increasing, and safe use of the unmanned aerial vehicles has attracted increasing attention.

For unmanned aerial vehicles in the related art, there is a requirement for flatness of a terrain for takeoff and landing. Taking an unmanned aerial vehicle with a fixed base as an example, if a ground of a landing site of the unmanned aerial vehicle is uneven, there is a risk that the unmanned aerial vehicle may roll over when landing. Similarly, if a ground of a take-off site of the unmanned aerial vehicle is uneven, which results in that a fuselage of the unmanned aerial vehicle cannot be kept in a horizontal state, and then there will be a risk that the unmanned aerial vehicle may roll over when the unmanned aerial vehicle takes off.

### SUMMARY

In order to solve the above technical problems, according to a first aspect, a method for detecting landing of an unmanned aerial vehicle is provided. The unmanned aerial vehicle includes a plurality of supporting vertical rods with an adjustable length. The method for detecting landing includes: acquiring a current ground clearance of each supporting vertical rod; acquiring a current height above ground of the unmanned aerial vehicle when receiving a landing instruction; determining whether a fuselage of the unmanned aerial vehicle is horizontal when the current height above ground reaches a preset height node; when the fuselage of the unmanned aerial vehicle is horizontal, adjusting a length of the supporting vertical rod according to the current ground clearance of the supporting vertical rod to keep the fuselage horizontal when the unmanned aerial vehicle lands; and controlling the unmanned aerial vehicle to descend for landing.

In order to solve the above technical problems, according to a second aspect, an electronic device is provided, which includes: at least one processor; and a memory communicatively connected with the at least one processor. The memory stores instructions executable by the at least one processor, and the instructions, when executed by the at least one processor, cause the at least one processor to execute the method for detecting landing of an unmanned aerial vehicle described above.

In order to solve the above technical problems, according to a third aspect, a nonvolatile computer storage medium is provided. The computer storage medium stores computer-executable instructions, and the computer-executable instructions, when executed by one or more processors, cause the one or more processors to execute the method for detecting landing of an unmanned aerial vehicle described above.

In order to solve the above technical problems, according to a fourth aspect, an unmanned aerial vehicle is provided, which includes: a fuselage, a plurality of supporting bars being installed outside the fuselage, the other ends of the plurality of supporting bars being respectively connected with a supporting vertical rod, and the supporting vertical rod being a controllable telescopic rod; a plurality of ranging units, the plurality of ranging units being respectively installed below the plurality of supporting bars, and the ranging unit being configured to detect a distance between the corresponding supporting vertical rod and a detection target; a motor, the motor being configured to control the supporting vertical rod to extend or contract; a flight control system, the flight control system configured to execute the method for detecting landing of an unmanned aerial vehicle described above; and a power supply, the power supply being configured to be accommodated in the fuselage and to provide power for the motor, the ranging unit and the flight control system.

### BRIEF DESCRIPTION OF THE DRAWINGS

FIG. 1 is a schematic diagram of an application environment according to an embodiment of the present disclosure;

FIG. 2 is a schematic structural diagram of an unmanned aerial vehicle according to an embodiment of the present disclosure;

FIG. 3 is a schematic flow chart of a method for detecting landing of an unmanned aerial vehicle according to an embodiment of the present disclosure;

FIG. 4 is a schematic flow chart of another method for detecting landing of an unmanned aerial vehicle according to an embodiment of the present disclosure;

FIG. 5 is a schematic structural diagram of an electronic device according to an embodiment of the present disclosure;

FIG. 6 is a schematic application diagram of a millimeter-wave radar ranging unit according to an embodiment of the present disclosure; and

FIG. 7 is a schematic application diagram of an ultrasonic ranging unit according to an embodiment of the present disclosure.

### DETAILED DESCRIPTION

The present disclosure will be described in detail with reference to specific embodiments. Following embodiments will aid those skilled in the art in further understanding the present disclosure, but do not limit the present disclosure in any way. It should be noted that, several modifications and improvements can be made by those of ordinary skill in the art without departing from the concept of the present disclosure. These are all within the protection scope of the present disclosure.

To make the objectives, technical solutions, and advantages of the present disclosure clearer, the following further describes the present disclosure in detail with reference to the accompanying drawings and the embodiments. It should be understood that the specific embodiments described herein are only used to explain the present disclosure, and are not intended to limit the present disclosure.

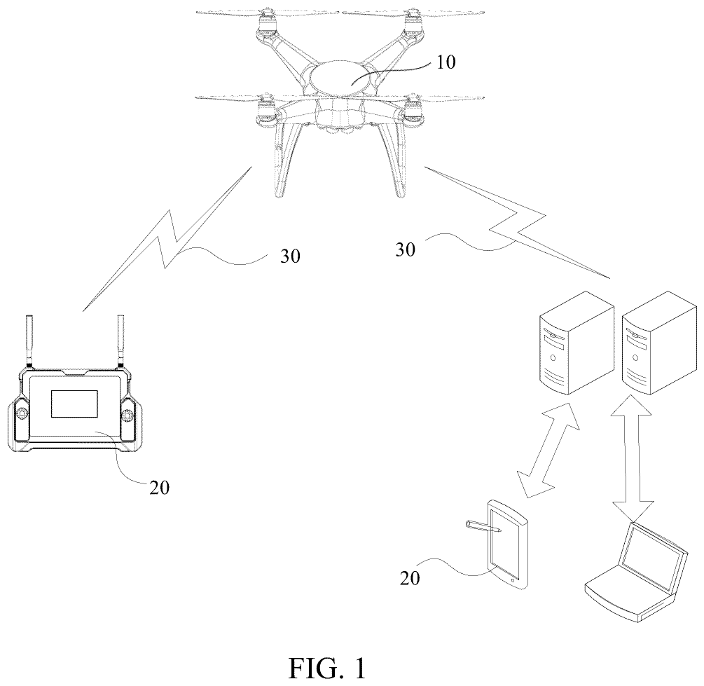

FIG. 1 shows an application environment according to an embodiment of the present disclosure. As shown in FIG. 1, the application environment takes an unmanned aerial vehicle system as an example, which includes an unmanned aerial vehicle 10, a remote control device 20 and a wireless network 30.

The unmanned aerial vehicle 10 can be an unmanned flying vehicle driven by any type of power (such as electricity), including but not limited to a quad-copter unmanned aerial vehicle, a fixed-wing aircraft and a helicopter model. In this embodiment, the quad-copter unmanned aerial vehicle is taken as an example. A fuselage of the unmanned aerial vehicle 10 can be equipped with several different functional modules, which can be software modules, hardware modules or modular apparatuses combining software and hardware to realize one or more functions.

In some embodiments, the unmanned aerial vehicle 10 may include a fuselage, arms, power units, and a flight controller. The fuselage is a main structure of the unmanned aerial vehicle 10, which is used for providing enough space to accommodate one or more components. The fuselage can have a suitable volume and shape according to actual situations and be made of corresponding materials.

The arm is a part extending outward from the fuselage, which is used as an installation or fixing structure of a propeller and other power units of the unmanned aerial vehicle 10. The arm can be integrally formed with the fuselage, or can be detachably connected with the fuselage. Typically, on the quad-copter unmanned aerial vehicle, four arms can be provided and extend symmetrically along a diagonal to form installation positions of four propellers.

The power unit can specifically be a structural apparatus driven by any type of energy, installed and fixed at the installation position at an end of the arm, and used for providing flight power for the unmanned aerial vehicle 10. For example, a propeller driven by a motor can be adopted. Power provided by the power unit or a structure actually adopted can be determined according to needs in an actual situation.

The flight controller is a control core of the unmanned aerial vehicle 10 built in the fuselage. The flight controller can be any type of electronic device with appropriate logical decision and computing power, including but not limited to a processor chip implemented based on large-scale integrated circuits, an integrated system-on-a-chip (SOC), as well as a processor and a storage media connected through a bus.

The remote control device 20 can be any type of apparatus, such as a remote controller, for establishing communication connection with the unmanned aerial vehicle 10 and controlling the unmanned aerial vehicle 10. The remote controller 20 can be equipped with one or more different user interaction apparatuses. Based on these user interaction apparatuses, user instructions can be collected or information can be displayed and fed back to users, so as to realize interaction between the user and the unmanned aerial vehicle 10.

These interaction apparatuses include, but are not limited to: a button, a scroll wheel, a display screen, a touch screen, a mouse, a speaker and a joystick. For example, the remote control device 20 can be equipped with a display screen, through which a remote control instruction of the user for the unmanned aerial vehicle 10 is received and an aerial image is displayed to the user, or a corresponding simulated driving interface is presented to the user, and one or more flight parameters, such as a flight speed, a heading or remaining power, are displayed on the simulated driving interface.

In other embodiments, the remote control device 20 can also be implemented by an intelligent terminal. The intelligent terminal includes, but is not limited to, a smart phone, a tablet computer, a laptop computer, a wearable device and the like. The intelligent terminal is configured to establish communication connection with the unmanned aerial vehicle by running a specially set APP client or a web terminal, so as to realize data transmission and reception with the unmanned aerial vehicle.

The wireless network 30 may be a wireless communication network for establishing a data transmission channel between two nodes based on any type of data transmission principle. For example, it can be a Bluetooth network, a WiFi network, a wireless cellular network or a combination thereof in different signal frequency bands. A specific frequency band or network form used by the wireless network 30 is related to a communication device adopted by the unmanned aerial vehicle 10 and the remote control device 20.

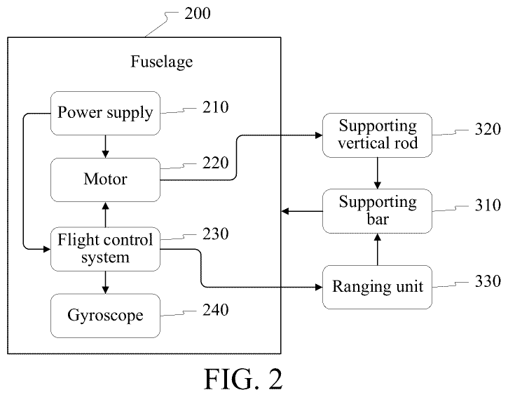

The method for detecting landing described above is applied to an unmanned aerial vehicle including a plurality of supporting vertical rods with an adjustable length. A structure of the unmanned aerial vehicle is shown in FIG. 2. In an embodiment, there are four supporting vertical rods with the adjustable length, and the unmanned aerial vehicle 10 includes:

a fuselage 200, a power supply 210, a motor 220, a flight control system 230, a gyroscope 240, four supporting bars 310, four supporting vertical rods 320 and four ranging units 330. The four supporting bars 310 are respectively installed at two sides of the fuselage 200; the other ends of the supporting bars 310 are respectively connected with one supporting vertical rod 320; and the four ranging units 330 are respectively installed below the four supporting bars 310. The four supporting vertical rods 320 are all controllable telescopic rods.

The fuselage 200 is internally provided with a power system for driving the unmanned aerial vehicle to fly, and the power supply 210 is accommodated in the fuselage 200 for providing power for the motor 220, the flight control system 230, the gyroscope 240 and the four ranging units 330.

The ranging unit 330 is configured to detect a distance between the supporting vertical rod 320 and a detection target. In this embodiment, the detection target is the ground, that is, the ranging unit 330 is configured to detect a ground clearance of the corresponding supporting vertical rod 320 and transmit the data to the flight control system 230.

The gyroscope 230 is an angular motion detection device that enables an angular momentum-sensitive shell of a high-speed rotator around one or two axes orthogonal to a rotation axis relative to an inertial space. In this embodiment, the gyroscope 240 is configured to acquire current attitude information of the unmanned aerial vehicle and to feed the attitude information back to the flight control system 230.

The motor 220 is configured to control the supporting vertical rod 320 to extend or contract, and in this embodiment, the motor 220 is a four-wire stepper motor. A stepper motor is a motor which converts an electrical pulse signal into corresponding angular displacement or linear displacement. The stepper motor includes a motor driving chip, which drives the stepper motor to rotate, thus driving the telescopic rod to extend or contract, so as to control the extension or contraction of the supporting vertical rod 320.

The flight control system 230 can stabilize a flight attitude of the unmanned aerial vehicle and control the unmanned aerial vehicle to fly autonomously or semi-autonomously, and is a core system for the unmanned aerial vehicle to complete an entire flight process involving take-off, air flight, mission execution and return recovery. The flight control system 230 is respectively connected to the motor 220, the gyroscope 240 and the four ranging units 330. The flight control system 230 establishes communication connection with a control terminal through wireless connection. After receiving a landing signal sent from the control terminal, the flight control system 230 controls the unmanned aerial vehicle 10 to land.

During landing of the unmanned aerial vehicle, the flight control system 230 controls the ranging units 330 to continuously detect the ground clearance of the corresponding supporting vertical rods 320. Taking a minimum value of the ground clearances of the supporting vertical rods 320 as a height above ground of the unmanned aerial vehicle, the flight control system 230 determines whether the height above ground is less than a preset height node during continuous landing of the unmanned aerial vehicle 10. If the height above ground is less than the preset height node, the unmanned aerial vehicle 10 is controlled to hover, and the gyroscope 240 is controlled to acquire the current attitude information of the unmanned aerial vehicle, and whether the fuselage 200 of the unmanned aerial vehicle 10 is horizontal is determined according to the attitude information, and if the fuselage 200 of the unmanned aerial vehicle 10 is not horizontal, the fuselage 200 is adjusted to be horizontal. If the fuselage 200 of the unmanned aerial vehicle 10 is horizontal at this time, the ranging units 330 are controlled to detect the ground clearances of the corresponding supporting vertical rods 320.

It should be noted that, the ground clearance of the supporting vertical rod 320 is equal to a detection distance detected by the ranging unit 330 minus a default length of the supporting vertical rod 320. The default length is a length when the supporting vertical rod is not extended.

The supporting vertical rod 320 with the height above ground is taken as a first supporting vertical rod and the length of the first supporting vertical rod is kept unchanged. A difference between the ground clearance of one other supporting vertical rod except the first supporting vertical rod and the height above ground is taken as a first adjustment value, and the motor driving chip in the motor 220 is controlled through a serial bus according to the first adjustment value to drive the motor 220 to control the corresponding supporting vertical rod to extend, so that the ground clearance of the other supporting vertical rod minus the first adjustment value is equal to the height above ground.

The unmanned aerial vehicle 10 described above takes the minimum value of the ground clearances of the supporting vertical rods 320 as the height above ground of the unmanned aerial vehicle. In other embodiments, the unmanned aerial vehicle includes:

a fuselage 200, a power supply 210, a motor 220, a flight control system 230, a gyroscope 240, four supporting bars 310, four supporting vertical rods 320 and five ranging units 330. The four supporting bars 310 are respectively installed at two sides of the fuselage 220; the other ends of the supporting bars 310 are respectively connected with one supporting vertical rod 320; and four ranging units 330 are respectively installed below the four supporting bars 310 and the fifth ranging unit 330 is installed at a bottom of the fuselage 220. The four supporting vertical rods 320 are all controllable telescopic rods.

The fuselage 200 is internally provided with a power system for driving the unmanned aerial vehicle 10 to fly, and the power supply 210 is accommodated in the fuselage 200 for providing power for the motor 220, the flight control system 230, the gyroscope 240 and the five ranging units 330.

The ranging unit 330 is configured to detect a distance between the supporting vertical rod 320 and a detection target. In this embodiment, the detection target is the ground, that is, the ranging unit 330 is configured to detect a ground clearance of the corresponding supporting vertical rod 320 and transmit the data to the flight control system 230.

It should be noted that, the ground clearance of the supporting vertical rod 320 is equal to a detection distance detected by the ranging unit 330 minus a default length of the supporting vertical rod 320. The default length is a length when the supporting vertical rod is not extended.

The gyroscope 230 is an angular motion detection device that enables an angular momentum-sensitive shell of a high-speed rotator around one or two axes orthogonal to a rotation axis relative to an inertial space. In this embodiment, the gyroscope 240 is configured to acquire current attitude information of the unmanned aerial vehicle and to feed the attitude information back to the flight control system 230.

The motor 220 is configured to control the supporting vertical rod 320 to extend or contract, and in this embodiment, the motor 220 is a four-wire stepper motor. A stepper motor is a motor which converts an electrical pulse signal into corresponding angular displacement or linear displacement. The stepper motor includes a motor driving chip, which drives the stepper motor to rotate, thus driving the telescopic rod to extend or contract, so as to control the extension or contraction of the supporting vertical rod 320.

The flight control system 230 can stabilize a flight attitude of the unmanned aerial vehicle 10, and control the unmanned aerial vehicle 10 to fly autonomously or semi-autonomously. The flight control system 230 is a core system for the unmanned aerial vehicle to complete an entire flight process involving take-off, air flight, mission execution and return recovery. The flight control system 230 is respectively connected to the motor 220, the gyroscope 240 and the four ranging units 330. The flight control system 230 establishes communication connection with a control terminal through wireless connection. After receiving a landing signal sent from the control terminal, the flight control system 230 controls the unmanned aerial vehicle 10 to land.

During landing of the unmanned aerial vehicle, the flight control system 230 controls the ranging units 330 installed on the supporting vertical rods 320 to continuously detect the ground clearances of the corresponding supporting vertical rods 320 and controls the ranging unit 330 installed at the bottom of the fuselage 200 to continuously detect the ground clearance of the bottom of the fuselage 200. Taking the ground clearance of the bottom of the fuselage 200 as the height above ground of the unmanned aerial vehicle, the flight control system 230 determines whether the height above ground is less than the preset height node during continuous landing of the unmanned aerial vehicle. If the height above ground is less than the preset height node, the unmanned aerial vehicle is controlled to hover, and the gyroscope 240 is controlled to acquire the current attitude information of the unmanned aerial vehicle, and whether the fuselage 200 of the unmanned aerial vehicle 10 is horizontal is determined according to the attitude information, and if the fuselage 200 of the unmanned aerial vehicle is not horizontal, the fuselage 200 is adjusted to be horizontal. If the fuselage 200 of the unmanned aerial vehicle 10 is horizontal at this time, the ranging units 330 are controlled to detect the ground clearances of the corresponding supporting vertical rods 320.

A difference between the ground clearances of the supporting vertical rods 320 is taken as a second adjustment value, and the motor driving chip in the motor 220 is controlled through a serial bus according to the second adjustment value to drive the motor 220 to control the corresponding supporting vertical rod to extend, so that the fuselage 200 is kept horizontal when the unmanned aerial vehicle 10 lands.

Different from the prior art, in the embodiments of the present disclosure, the flatness of the landing site can be detected before landing, and the lengths of the supporting vertical rods are adjusted according to the ground clearances of the supporting vertical rods of the unmanned aerial vehicle, so that the fuselage can be kept horizontal when the unmanned aerial vehicle 10 lands, and rollover of the unmanned aerial vehicle caused by uneven ground when landing can be avoided.

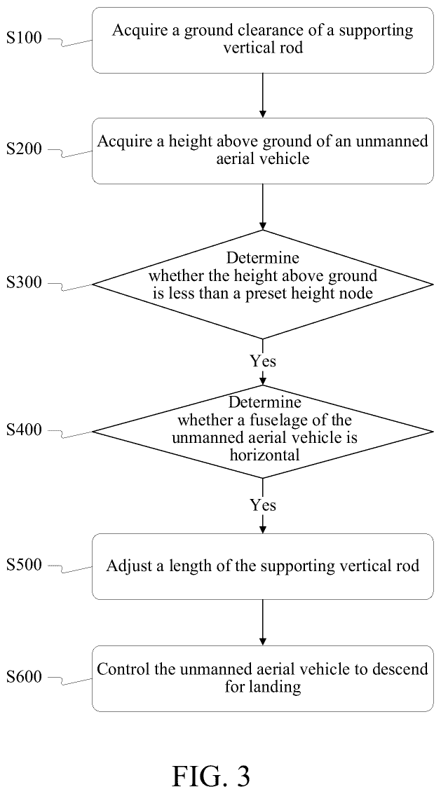

Based on the unmanned aerial vehicle as shown in FIG. 2, a method for detecting landing of an unmanned aerial vehicle is further provided in an embodiment of the present disclosure. Referring to FIG. 3, the method includes the following steps.

Step S100: A ground clearance of a supporting vertical rod is acquired.

A current ground clearance of each supporting vertical rod is acquired through a ranging unit corresponding to the supporting vertical rod.

Step S200: A height above ground of the unmanned aerial vehicle is acquired.

When the unmanned aerial vehicle receives a landing instruction during flight, a current height above ground of the unmanned aerial vehicle is acquired through the ranging unit.

In some embodiments, the number of the ranging units corresponds to the number of the supporting vertical rods, and an initial length of the supporting vertical rod is the shortest length thereof. At this time, the supporting vertical rods cannot be contracted, and they can only be contracted after being extended, so the height above ground of the unmanned aerial vehicle is a minimum value of the current ground clearances of the supporting vertical rods, and the ground clearances of the supporting vertical rods are acquired by the ranging units corresponding to the supporting vertical rods.

It should be noted that, if the minimum value of the current ground clearances of the supporting vertical rods is taken as the height above ground of the unmanned aerial vehicle, the current ground clearances of the supporting vertical rods need to be acquired before acquiring the height above ground of the unmanned aerial vehicle.

It should be noted that, a maximum value of the current ground clearances of the supporting vertical rods can also be used as the height above ground of the unmanned aerial vehicle, which needs to be selected according to application scenario. In addition, when applied to unmanned aerial vehicles with more ranging units than supporting vertical rods, the ranging units other than those used for measuring the ground clearances of the supporting vertical rods can be selected to acquire the current height above ground of the unmanned aerial vehicle. The height above ground of the unmanned aerial vehicle is selected according to a specific application object.

In other embodiments, in addition to the ranging units corresponding to the supporting vertical rods, a ranging unit is further installed at a bottom of the fuselage of the unmanned aerial vehicle. At this time, the height above ground of the unmanned aerial vehicle is the ground clearance acquired by the ranging unit installed at the bottom of the fuselage of the unmanned aerial vehicle.

Step S300: Whether the height above ground is less than a preset height node is determined.

The height above ground obtained in step S200 is compared with the preset height node to determine whether the height above ground is less than the preset height node. If the height above ground is less than the preset height node, step S400 is executed.

In some embodiments, the preset height node is a half of a maximum length of the supporting vertical rod. Taking the supporting vertical rod with a maximum length of 1 m as an example, the preset height node is 50 cm. If the height above ground is less than 50 cm, step S400 is executed. The preset height node is used as a starting node of a program to reduce computing load of the unmanned aerial vehicle. The preset height node is selected according to a safe height of the unmanned aerial vehicle when landing. Theoretically, the larger the preset height node is, the safer the landing of the unmanned aerial vehicle. However, the greater the measuring distance, the lower the measuring accuracy of the ranging unit. Therefore, the preset height node needs to choose an appropriate value according to the application scenario.

Step S400: Whether the fuselage of the unmanned aerial vehicle is horizontal is determined.

When the height above ground obtained in step S200 is less than the preset height node, the unmanned aerial vehicle is controlled to hover at a current height position, and current attitude information of the unmanned aerial vehicle is fed back by the gyroscope, and whether the fuselage of the current unmanned aerial vehicle is horizontal is determined according to the attitude information, and if the fuselage of the current unmanned aerial vehicle is horizontal, step S500 is executed.

Step S500: A length of the supporting vertical rod is adjusted.

According to the current ground clearances of the supporting vertical rods acquired in step S100, the length of the supporting vertical rod is adjusted to enable the length of the supporting vertical rod to match current terrain information, so that the fuselage is kept horizontal when the unmanned aerial vehicle lands.

In some embodiments, the height above ground of the unmanned aerial vehicle is the minimum value of the current ground clearances of the supporting vertical rods. Therefore, the supporting vertical rod with the height above ground is taken as the first supporting vertical rod and the length of the first supporting vertical rod is kept unchanged.

Preferably, a difference between the ground clearance of one other supporting vertical rod except the first supporting vertical rod and the height above ground is taken as the first adjustment value, the motor is controlled according to the first adjustment value to extend the corresponding supporting vertical rod, so that the ground clearance of the other supporting vertical rod minus the first adjustment value is equal to the height above ground.

In some other embodiments, when the height above ground of the unmanned aerial vehicle is the ground clearance acquired by the ranging unit installed at the bottom of the fuselage of the unmanned aerial vehicle, the current ground clearance of the supporting vertical rod is taken as the first adjustment value, and the motor is controlled to adjust the corresponding supporting vertical rods according to the first adjustment value, so that each supporting vertical rod directly contacts the ground.

Step S600: The unmanned aerial vehicle is controlled to descend for landing.

Different from the prior art, in the embodiments of the present disclosure, the flatness of the landing site can be detected before the unmanned aerial vehicle lands, and the lengths of the supporting vertical rods are adjusted according to the ground clearances of the supporting vertical rods of the unmanned aerial vehicle, so that the fuselage can be kept horizontal when the unmanned aerial vehicle lands, and rollover of the unmanned aerial vehicle caused by uneven ground when landing can be avoided.

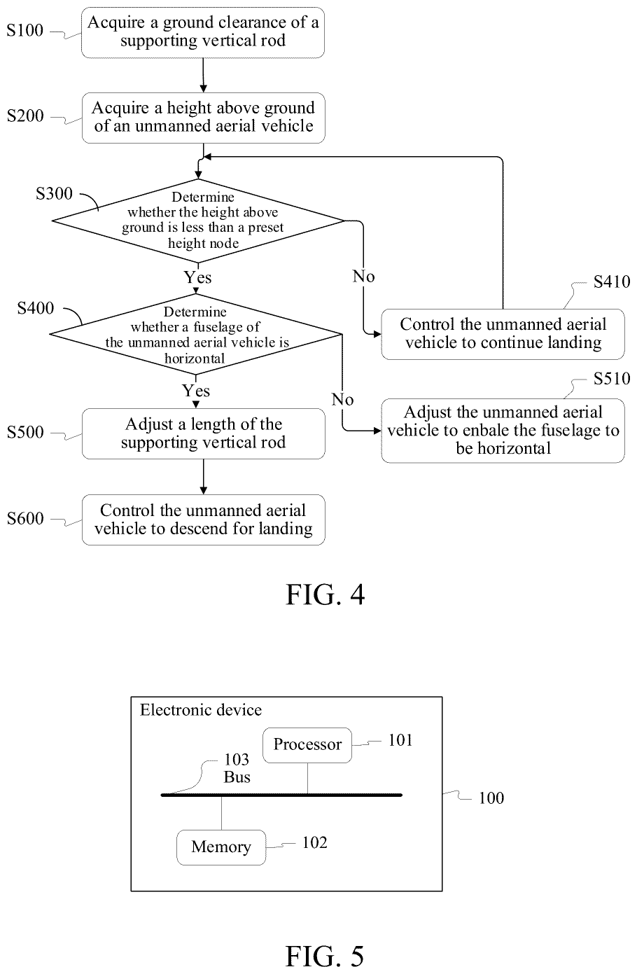

In the above embodiment, when the height above ground is not less than the preset height node, the method further includes step S410. When the fuselage of the unmanned aerial vehicle is not horizontal, the method further includes step S510. As shown in FIG. 4, FIG. 4 is a schematic flow chart of another method for detecting landing of an unmanned aerial vehicle according to an embodiment of the present disclosure, the method includes the following steps.

Step S100: A ground clearance of a supporting vertical rod is acquired.

A current ground clearance of each supporting vertical rod is acquired through a ranging unit corresponding to the supporting vertical rod.

Step S200: A height above ground of the unmanned aerial vehicle is acquired.

The present disclosure is applied to an unmanned aerial vehicle including a plurality of supporting vertical rods with an adjustable length, and when the unmanned aerial vehicle receives a landing instruction during flight, a current height above ground of the unmanned aerial vehicle is acquired with the ranging unit.

In some embodiments, the number of the ranging units corresponds to the number of the supporting vertical rods, and an initial length of the supporting vertical rod is the shortest length thereof. At this time, the supporting vertical rods cannot be contracted, and they can only be contracted after being extended, so the height above ground of the unmanned aerial vehicle is a minimum value of the current ground clearances of the supporting vertical rods, and the ground clearances of the supporting vertical rods are acquired by the ranging units corresponding to the supporting vertical rods.

It should be noted that, a maximum value of the current ground clearances of the supporting vertical rods can also be used as the height above ground of the unmanned aerial vehicle, which needs to be selected according to application scenario. In addition, when applied to unmanned aerial vehicles with more ranging units than supporting vertical rods, the ranging units other than those used for measuring the ground clearances of the supporting vertical rods can be selected to acquire the current height above ground of the unmanned aerial vehicle. The height above ground of the unmanned aerial vehicle is selected according to a specific application object.

In other embodiments, in addition to the ranging units corresponding to the supporting vertical rods, a ranging unit is further installed at a bottom of the fuselage of the unmanned aerial vehicle. At this time, the height above ground of the unmanned aerial vehicle is the ground clearance acquired by the ranging unit installed at the bottom of the fuselage of the unmanned aerial vehicle.

Step S300: Whether the height above ground is less than a preset height node is determined.

The height above ground obtained in step S200 is compared with the preset height node to determine whether the height above ground is less than the preset height node. If the height above ground is less than the preset height node, step S400 is executed; and if the height above ground is not less than the preset height node, step S410 is executed.

In some embodiments, the preset height node is a half of a maximum length of the supporting vertical rod. Taking the supporting vertical rod with a maximum length of 1 m as an example, the preset height node is 50 cm. If the height above ground is less than 50 cm, step S400 is executed. The preset height node is used as a starting node of a program to reduce computing load of the unmanned aerial vehicle. The preset height node is selected according to a safe height of the unmanned aerial vehicle when landing. Theoretically, the larger the preset height node is, the safer the landing of the unmanned aerial vehicle. However, the greater the measuring distance, the lower the measuring accuracy of the ranging unit. Therefore, the preset height node needs to choose an appropriate value according to the application scenario.

Step S400: Whether the fuselage of the unmanned aerial vehicle is horizontal is determined.

When the height above ground obtained in step S200 is less than the preset height node, the unmanned aerial vehicle is controlled to hover at a current height position, and current attitude information of the unmanned aerial vehicle is fed back by the gyroscope, and whether the fuselage of the current unmanned aerial vehicle is horizontal is determined according to the attitude information. If the fuselage of the current unmanned aerial vehicle is horizontal, step S500 is executed; and if the fuselage of the current unmanned aerial vehicle is not horizontal, step S510 is executed.

Step S410: The unmanned aerial vehicle is controlled to continue landing.

Step S510: The unmanned aerial vehicle is adjusted to enable the fuselage to be horizontal.

Step S500: A length of the supporting vertical rod is adjusted.

According to the current ground clearances of the supporting vertical rods acquired in step S100, the length of the supporting vertical rod is adjusted to enable the length of the supporting vertical rod to match current terrain information, so that the fuselage is kept horizontal when the unmanned aerial vehicle lands.

In some embodiments, the height above ground of the unmanned aerial vehicle is the minimum value of the current ground clearances of the supporting vertical rods. Therefore, the supporting vertical rod with the height above ground is taken as the first supporting vertical rod and the length of the first supporting vertical rod is kept unchanged.

Preferably, a difference between the ground clearance of one other supporting vertical rod except the first supporting vertical rod and the height above ground is taken as the first adjustment value, the motor is controlled according to the first adjustment value to extend the corresponding supporting vertical rod, so that the ground clearance of the other supporting vertical rod minus the first adjustment value is equal to the height above ground.

In some other embodiments, when the height above ground of the unmanned aerial vehicle is the ground clearance acquired by the ranging unit installed at the bottom of the fuselage of the unmanned aerial vehicle, the current ground clearance of the supporting vertical rod is taken as the first adjustment value, and the motor is controlled to adjust the corresponding supporting vertical rods according to the first adjustment value, so that each supporting vertical rod directly contacts the ground.

Step S600: The unmanned aerial vehicle is controlled to descend for landing.

Based on the method for detecting landing of an unmanned aerial vehicle described above, the present disclosure provides another embodiment. Referring to FIG. 5, FIG. 5 is a schematic structural diagram of an electronic device according to an embodiment of the present disclosure, and the electronic device 100 includes:

one or more processors 101 and a memory 102, one processor 101 being taken as an example in FIG. 5.

The processor 101 and the memory 102 can be connected by a bus 103 or in other manners, and connection by the bus 103 is taken as an example in FIG. 5.

As a nonvolatile computer-readable storage medium, the memory 102 can be used for storing nonvolatile software programs, nonvolatile computer-executable programs and modules. The processor 101 executes various functional applications and data processing of the electronic device by running nonvolatile software programs, instructions and units stored in the memory 102, that is, implements the method for detecting landing of an unmanned aerial vehicle in the above method embodiments.

The memory 102 may include a storage program area and a storage data area. The storage program area may store an operating system and an application program required by at least one function. The storage data area can store data created according to use of electronic device, and the like. In addition, the memory 102 may include a high-speed random memory, and may also include a nonvolatile memory, for example, at least one magnetic storage device, a flash memory, or other nonvolatile solid-state memories. In some embodiments, the memory 102 alternatively includes memories remotely disposed relative to the processor 101, and the remote memories may be connected to the electronic device through a network. Examples of the network include, but are not limited to, Internet, intranet, local area network, mobile communication network, and a combination thereof.

The one or more units are stored in the memory 102, and when executed by the one or more processors 101, the method for detecting landing of an unmanned aerial vehicle in any of the above method embodiments is executed.

The electronic device 100 can execute the method for detecting landing of an unmanned aerial vehicle according to the embodiment of the present disclosure, and has corresponding program modules and beneficial effects for executing the method. For technical details that are not described in detail in the embodiment of the electronic device, reference can be made to the method for detecting landing of an unmanned aerial vehicle according to the embodiment of the present disclosure.

An embodiment of the present disclosure further provides a nonvolatile computer-readable storage medium, and the nonvolatile computer-readable storage medium can be included in the device described in the above embodiment, or can also exist separately without being assembled into the device. The nonvolatile computer-readable storage medium carries one or more programs, and when the one or more programs are executed, the method of the embodiment of the present disclosure is implemented.

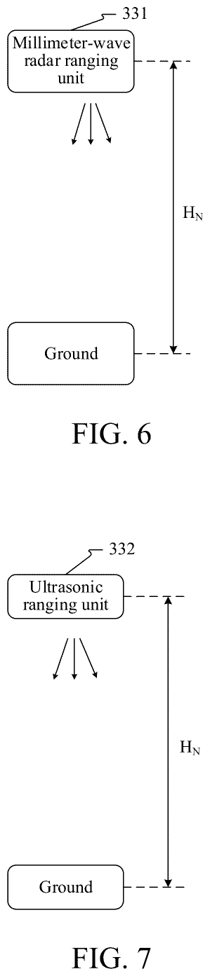

It should be noted that, the ranging unit 330 shown in FIG. 2 includes a millimeter-wave radar ranging unit 331 and an ultrasonic ranging unit 332. As shown in FIG. 6, which is a schematic application diagram of the millimeter-wave radar ranging unit according to an embodiment of the present disclosure, the millimeter-wave radar ranging unit 331 refers to a radar sensor apparatus operating in a millimeter wave band with a wavelength of 1 to 10 mm and a frequency of 30 to 300 GHz. In the embodiment of the present disclosure, there are four millimeter-wave radar ranging units 331, and each millimeter-wave radar ranging unit 331 emits radio waves (i.e., millimeter waves) through a transmitting antenna. When the radio waves reach a detection target (in this embodiment, the detection target is the ground), the radio waves may be reflected back to form target echo waves, and the target echo waves reflected back may be received by a receiving antenna, and then the millimeter-wave radar ranging unit 331 may calculate position data and a relative distance of the detection target according to a time difference between transmission and reception of the radio wave signals.

The formula for determining the ground clearance of the supporting vertical rod 320 according to the propagation speed of electromagnetic waves is:

H_{N}=ct/2 (1)

H_{N} represents the ground clearance of the supporting vertical rod 320, c represents the speed of light, and t represents the time from emitting of the radio waves from the millimeter-wave radar ranging unit 331 to reception of the target echo waves.

In the above embodiment, the supporting vertical rod 320 with the height above ground is taken as the first supporting vertical rod, the height above ground is set as H₁, and the ground clearances acquired for other supporting vertical rods are H₂, H₃ and H₄ respectively. The supporting vertical rod with H₂ is taken as a second supporting vertical rod, the supporting vertical rod with H₃ is taken as a third supporting vertical rod, and the supporting vertical rod with H₄ is taken as a fourth supporting vertical rod.

A first adjustment value of the second supporting vertical rod is calculated according to the following formula:

Δ₁=H₂−H₁ (2)

The motor driving chip in the motor 220 is controlled through the serial bus to drive the motor 220 to control the second supporting vertical rod to extend by Δ₁.

A first adjustment value of the third supporting vertical rod is calculated according to the following formula:

Δ₂=H₃−−H₁ (3)

The motor driving chip in the motor 220 is controlled through the serial bus to drive the motor 220 to control the third supporting vertical rod to extend by Δ₂.

A first adjustment value of the fourth supporting vertical rod is calculated according to the following formula:

Δ₃=H₄−H₁ (4)

The motor driving chip in the motor 220 is controlled through the serial bus to drive the motor 220 to control the fourth supporting vertical rod to extend by Δ₃. The ground clearances of the supporting vertical rods minus the first adjustment value are equal to the height above ground.

In some other embodiments, the ranging unit 330 includes an ultrasonic ranging unit 332. As shown in FIG. 7, which is a schematic application diagram of the ultrasonic ranging unit according to an embodiment of the present disclosure, and the ultrasonic ranging unit 332 is a radar sensor apparatus that uses ultrasonic waves to measure a distance. In the embodiment of the present disclosure, there are four ultrasonic ranging units 332, and each ultrasonic ranging unit 332 emits radio waves (i.e., ultrasonic waves) through an ultrasonic transmitter. When the radio waves reach a detection target (in this embodiment, the detection target is the ground), the radio waves may be reflected back to form target echo waves, and the target echo waves reflected back may be received by an ultrasonic receiver, and then the ultrasonic radar ranging unit 332 may calculate position data and a relative distance of the detection target according to a time difference between transmission and reception of the radio wave signals.

The formula for determining the ground clearance of the supporting vertical rod 320 according to the propagation speed of the ultrasonic waves is:

h_{N}=vt/2 (5)

h_{N} represents the ground clearance of the supporting vertical rod 320, v represents the speed of sound, and t represents the time from emitting of the radio waves from the ultrasonic radar ranging unit 332 to reception of the target echo waves.

In the above embodiment, the supporting vertical rod 320 with the height above ground is taken as the first supporting vertical rod, the height above ground is set as h₁, and the ground clearances acquired for other supporting vertical rods are h₂, h₃ and h₄ respectively. The supporting vertical rod with h₂ is taken as a second supporting vertical rod, the supporting vertical rod with h₃ is taken as a third supporting vertical rod, and the supporting vertical rod with h₄ is taken as a fourth supporting vertical rod.

A first adjustment value of the second supporting vertical rod is calculated according to the following formula:

Δ₄=h₂−h₁ (6)

The motor driving chip in the motor 220 is controlled through the serial bus to drive the motor 220 to control the second supporting vertical rod to extend by Δ₄.

A first adjustment value of the third supporting vertical rod is calculated according to the following formula:

Δ₅=h₃−h₁ (7)

The motor driving chip in the motor 220 is controlled through the serial bus to drive the motor 220 to control the third supporting vertical rod to extend by Δ₅.

A first adjustment value of the fourth supporting vertical rod is calculated according to the following formula:

Δ₆=h₄−h₁ (8)

The motor driving chip in the motor 220 is controlled through the serial bus to drive the motor 220 to control the fourth supporting vertical rod to extend by Δ₆.

In some embodiments, the height above ground is a minimum value of the current ground clearances of the plurality of supporting vertical rods.

In some embodiments, the height above ground also includes a ground clearance acquired by a ranging unit located at a bottom of the fuselage of the unmanned aerial vehicle.

In some embodiments, the preset height node is a half of a maximum length of the supporting vertical rod.

In some embodiments, the method further includes: determining whether the height above ground of the unmanned aerial vehicle is less than a preset height; when the height above ground of the unmanned aerial vehicle is not less than the preset height, controlling the unmanned aerial vehicle to continue to land to enable the height above ground to be less than the preset height; when the height above ground of the unmanned aerial vehicle is less than the preset height, controlling the unmanned aerial vehicle to hover.

In some embodiments, the method further includes: adjusting the fuselage of the unmanned aerial vehicle to make the fuselage of the unmanned aerial vehicle horizontal when the fuselage of the unmanned aerial vehicle is not horizontal.

In some embodiments, the length of the supporting vertical rod is adjusted to keep the fuselage horizontal by means of: taking the supporting vertical rod with the height above ground as a first supporting vertical rod and keeping the length of the first supporting vertical rod unchanged; and taking a difference between the ground clearance of one other supporting vertical rod except the first supporting vertical rod and the height above ground as a first adjustment value, and controlling a motor to adjust the corresponding supporting vertical rod according to the first adjustment value.

In some embodiments, the length of the supporting vertical rod is adjusted to keep the fuselage horizontal by means of: taking the current ground clearance of the supporting vertical rod as a first adjustment value, and controlling a motor to adjust the corresponding supporting vertical rod according to the first adjustment value.

In some embodiments, the ranging unit includes a millimeter-wave radar ranging unit or/and an ultrasonic ranging unit.

The embodiments of the present disclosure have the following beneficial effects: different from the situation in the related art, in the embodiments of the present disclosure, the flatness of the landing site can be detected before the unmanned aerial vehicle lands, and the lengths of the supporting vertical rods are adjusted according to the ground clearances of the supporting vertical rods of the unmanned aerial vehicle, so that the fuselage can be kept horizontal when the unmanned aerial vehicle lands, and rollover of the unmanned aerial vehicle caused by uneven ground when landing can be avoided.

The above is only embodiment of the present disclosure, and does not limit the patent scope of the present disclosure. Any equivalent structure or equivalent process transformation made by using contents of the specification and drawings of the present disclosure, or is directly or indirectly applied to other related technical fields, are equally included within the patent protection scope of the present disclosure.

What is claimed is:

1. A method for detecting landing of an unmanned aerial vehicle, the unmanned aerial vehicle comprising a plurality of supporting vertical rods with an adjustable length, wherein the method comprises:
acquiring a current ground clearance of each of the plurality of supporting vertical rods;
acquiring a current height above ground of the unmanned aerial vehicle in response to determining that a landing instruction is received;
determining whether a fuselage of the unmanned aerial vehicle is horizontal in response to determining that the current height above ground reaches a preset height node;
in response to determining that the fuselage of the unmanned aerial vehicle is horizontal, adjusting a length of the supporting vertical rod according to the current ground clearance of the supporting vertical rod to keep the fuselage horizontal when the unmanned aerial vehicle lands; and
controlling the unmanned aerial vehicle to descend for landing.

2. The method according to claim 1, wherein the height above ground comprises a minimum value of the current ground clearances of the plurality of supporting vertical rods.

3. The method according to claim 1, wherein the height above ground further comprises a ground clearance acquired by a ranging unit located at a bottom of the fuselage of the unmanned aerial vehicle.

4. The method according to claim 1, wherein the preset height node is a half of a maximum length of the supporting vertical rod.

5. The method according to claim 1, further comprising:
determining whether the height above ground of the unmanned aerial vehicle is less than a preset height;
in response to determining that the height above ground of the unmanned aerial vehicle is not less than the preset height, controlling the unmanned aerial vehicle to continue to land to enable the height above ground to be less than the preset height; and
in response to determining that the height above ground of the unmanned aerial vehicle is less than the preset height, controlling the unmanned aerial vehicle to hover.

6. The method according to claim 1, further comprising:
adjusting the fuselage of the unmanned aerial vehicle to make the fuselage of the unmanned aerial vehicle horizontal in response to determining that the fuselage of the unmanned aerial vehicle is not horizontal.

7. The method according to claim 2, wherein adjusting the length of the supporting vertical rod to keep the fuselage horizontal comprises:
taking the supporting vertical rod with the height above ground as a first supporting vertical rod and keeping the length of the first supporting vertical rod unchanged; and
taking a difference between the ground clearance of one other supporting vertical rod except the first supporting vertical rod and the height above ground as a first adjustment value, and controlling a motor to adjust the corresponding supporting vertical rod according to the first adjustment value.

8. The method according to claim 3, wherein adjusting the length of the supporting vertical rod to keep the fuselage horizontal comprises:
taking the current ground clearance of the supporting vertical rod as a first adjustment value, and controlling a motor to adjust the corresponding supporting vertical rod according to the first adjustment value.

9. An electronic device, comprising:
at least one processor; and
a memory communicatively connected with the at least one processor; wherein
the memory stores instructions executable by the at least one processor, and the instructions, when executed by the at least one processor, cause the at least one processor to execute a plurality of operations, wherein the unmanned aerial vehicle comprises a plurality of supporting vertical rods with an adjustable length, and the plurality of operations comprise:
acquiring a current ground clearance of each of the plurality of supporting vertical rods;
acquiring a current height above ground of the unmanned aerial vehicle in response to determining that a landing instruction is received;
determining whether a fuselage of the unmanned aerial vehicle is horizontal in response to determining that the current height above ground reaches a preset height node;
in response to determining that the fuselage of the unmanned aerial vehicle is horizontal, adjusting a length of the supporting vertical rod according to the current ground clearance of the supporting vertical rod to keep the fuselage horizontal when the unmanned aerial vehicle lands; and
controlling the unmanned aerial vehicle to descend for landing.

10. The electronic device according to claim 9, wherein the plurality of operations further comprise:
determining whether the height above ground of the unmanned aerial vehicle is less than a preset height;
in response to determining that the height above ground of the unmanned aerial vehicle is not less than the preset height, controlling the unmanned aerial vehicle to continue to land to enable the height above ground to be less than the preset height; and
in response to determining that the height above ground of the unmanned aerial vehicle is less than the preset height, controlling the unmanned aerial vehicle to hover.

11. The electronic device according to claim 9, wherein the plurality of operations further comprise:
adjusting the fuselage of the unmanned aerial vehicle to make the fuselage of the unmanned aerial vehicle horizontal in response to determining that the fuselage of the unmanned aerial vehicle is not horizontal.

12. An unmanned aerial vehicle, comprising:
a fuselage;
a plurality of supporting vertical rods with an adjustable length;
a plurality of supporting bars being installed outside the fuselage, the other ends of the plurality of supporting bars being respectively connected with a supporting vertical rod, and the supporting vertical rod being a controllable telescopic rod;
a plurality of ranging units, the plurality of ranging units being respectively installed below the plurality of supporting bars, and the ranging unit being configured to detect a distance between the corresponding supporting vertical rod and a detection target;
a motor, the motor being configured to control the supporting vertical rod to extend or contract;
a flight control system, the flight control system being configured to execute a method for detecting landing of an unmanned aerial vehicle; and
a power supply, the power supply being configured to be accommodated in the fuselage and to provide power for the motor, the ranging unit and the flight control system;
wherein the flight control system is configured to:
acquire a current ground clearance of each of the plurality of supporting vertical rods;
acquire a current height above ground of the unmanned aerial vehicle in response to determining that a landing instruction is received;
determine whether a fuselage of the unmanned aerial vehicle is horizontal in response to determining that the current height above ground reaches a preset height node;
in response to determining that the fuselage of the unmanned aerial vehicle is horizontal, adjust a length of the supporting vertical rod according to the current ground clearance of the supporting vertical rod to keep the fuselage horizontal when the unmanned aerial vehicle lands; and
control the unmanned aerial vehicle to descend for landing.

13. The unmanned aerial vehicle according to claim 12, wherein the ranging unit comprises a millimeter-wave radar ranging unit or/and an ultrasonic ranging unit.

14. The unmanned aerial vehicle according to claim 12, wherein the height above ground comprises a minimum value of the current ground clearances of the plurality of supporting vertical rods.

15. The unmanned aerial vehicle according to claim 12, wherein the height above ground further comprises a ground clearance acquired by the ranging unit located at a bottom of the fuselage of the unmanned aerial vehicle.

16. The unmanned aerial vehicle according to claim 12, wherein the preset height node is a half of a maximum length of the supporting vertical rod.

17. The unmanned aerial vehicle according to claim 12, wherein the flight control system is further configured to:
determine whether the height above ground of the unmanned aerial vehicle is less than a preset height;
in response to determining that the height above ground of the unmanned aerial vehicle is not less than the preset height, control the unmanned aerial vehicle to continue to land to enable the height above ground to be less than the preset height;
in response to determining that the height above ground of the unmanned aerial vehicle is less than the preset height, control the unmanned aerial vehicle to hover.

18. The unmanned aerial vehicle according to claim 12, the flight control system further is configured to:
adjust the fuselage of the unmanned aerial vehicle to make the fuselage of the unmanned aerial vehicle horizontal in response to determining that the fuselage of the unmanned aerial vehicle is not horizontal.

19. The unmanned aerial vehicle according to claim 14, wherein the flight control system is further configured to:
take the supporting vertical rod with the height above ground as a first supporting vertical rod and keep the length of the first supporting vertical rod unchanged; and
take a difference between the ground clearance of one other supporting vertical rod except the first supporting vertical rod and the height above ground as a first adjustment value, and control a motor to adjust the corresponding supporting vertical rod according to the first adjustment value.

20. The unmanned aerial vehicle according to claim 15, wherein the flight control system further is configured to:
take the current ground clearance of the supporting vertical rod as a first adjustment value, and control a motor to adjust the corresponding supporting vertical rod according to the first adjustment value.
